(19) United States
(12) Patent Application Publication
(10) Pub. No.: US 2025/0337960 A1
(43) Pub. Date: Oct. 30, 2025

(54) METHOD, APPARATUS, AND MEDIUM FOR VIDEO PROCESSING

(71) Applicant: Bytedance Inc., Los Angeles, CA (US)

(72) Inventors: Jizheng XU, Los Angeles, CA (US); Ye-Kui WANG, Los Angeles, CA (US); Li ZHANG, Los Angeles, CA (US); Yue LI, Los Angeles, CA (US)

(21) Appl. No.: 19/260,110

(22) Filed: Jul. 3, 2025

Related U.S. Application Data
(63) Continuation of application No. PCT/US2024/010198, filed on Jan. 3, 2024.
(60) Provisional application No. 63/478,310, filed on Jan. 3, 2023.
(60) Provisional application No. 63/437,077, filed on Jan. 4, 2023.

(51) Int. Cl. H04N 19/80; H04N 19/184; H04N 19/70; H04N 19/85

(52) U.S. Cl. CPC H04N 19/80; H04N 19/184; H04N 19/70; H04N 19/85

(57) ABSTRACT

Embodiments of the present disclosure provide a solution for video processing. A method for video processing is proposed. The method comprises: performing a conversion between a video and a bitstream of the video, wherein a neural-network post-processing filter (NNPF) is applied on at least one picture associated with the video, the bitstream comprises a first indication indicating a purpose of the NNPF, one of a plurality of candidates for the purpose corresponds to a bit mask, and the bit mask is used for determining the purpose of the NNPF based on the first indication.

### CROSS REFERENCE

This application is a continuation of International Application No. PCT/US2024/010198, filed on Jan. 3, 2024, which claims the benefit of U.S. Provisional Application No. 63/478,310 filed on Jan. 3, 2023, and U.S. Provisional Application No. 63/437,077 filed on Jan. 4, 2023. The entire contents of these applications are hereby incorporated by reference in their entireties.

### FIELDS

Embodiments of the present disclosure relates generally to video processing techniques, and more particularly, to a neural-network post-processing filter (NNPF).

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: performing a conversion between a video and a bitstream of the video, wherein a neural-network post-processing filter (NNPF) is applied on at least one picture associated with the video, the bitstream comprises a first indication indicating a purpose of the NNPF, one of a plurality of candidates for the purpose corresponds to a bit mask, and the bit mask is used for determining the purpose of the NNPF based on the first indication.

According to the method in accordance with the first aspect of the present disclosure, one of a plurality of candidates for the purpose of the NNPF corresponds to a bit mask that is used for determining the purpose of the NNPF based on the first indication. Compared with the conventional solution, the proposed method advantageously provides a systematic scheme for signaling the purpose of the NNPF, and thus supports a possible extension of the purpose. Thereby, potential instability and logical issues can be avoided, and the coding efficiency can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: performing a conversion between the video and the bitstream, wherein a neural-network post-processing filter (NNPF) is applied on at least one picture associated with the video, the bitstream comprises a first indication indicating a purpose of the NNPF, one of a plurality of candidates for the purpose corresponds to a bit mask, and the bit mask is used for determining the purpose of the NNPF based on the first indication.

In a fifth aspect, a method for storing a bitstream of a video is proposed. The method comprises: performing a conversion between the video and the bitstream, wherein a neural-network post-processing filter (NNPF) is applied on at least one picture associated with the video, the bitstream comprises a first indication indicating a purpose of the NNPF, one of a plurality of candidates for the purpose corresponds to a bit mask, and the bit mask is used for determining the purpose of the NNPF based on the first indication; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an illustration of luma data channels;

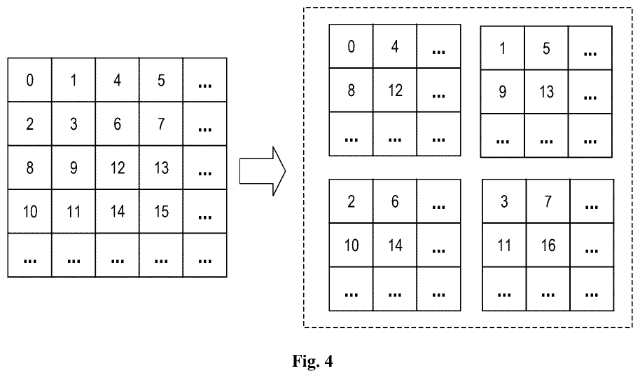

FIG. 5 illustrates a flowchart of a method for video processing in accordance with embodiments of the present disclosure; and

FIG. 6 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

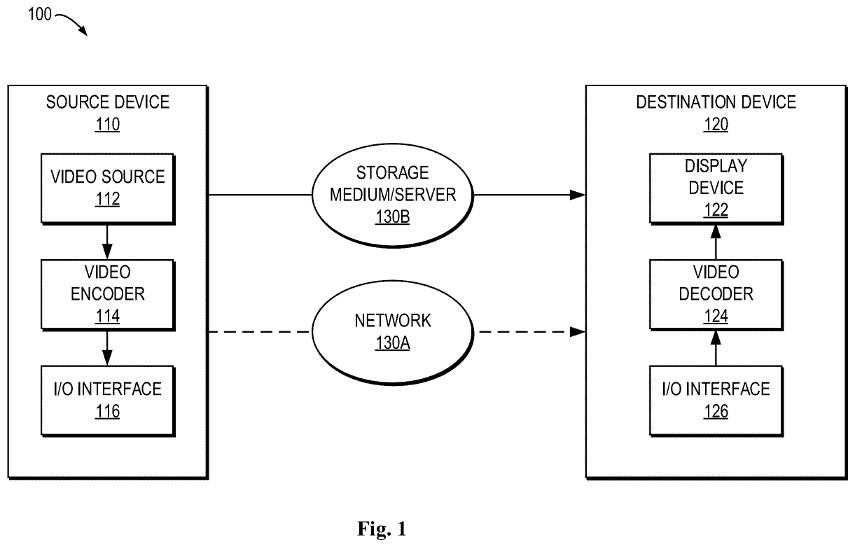

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

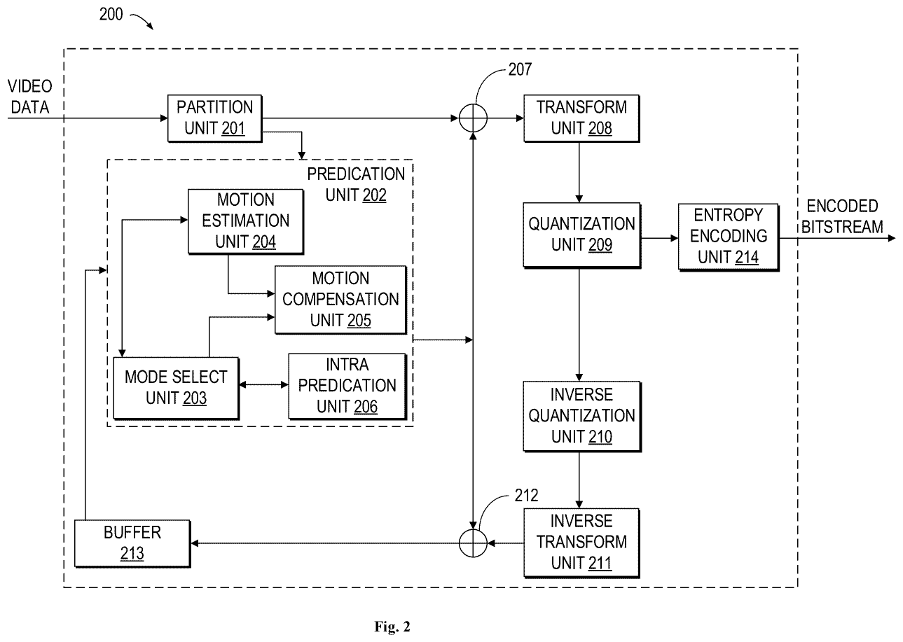

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

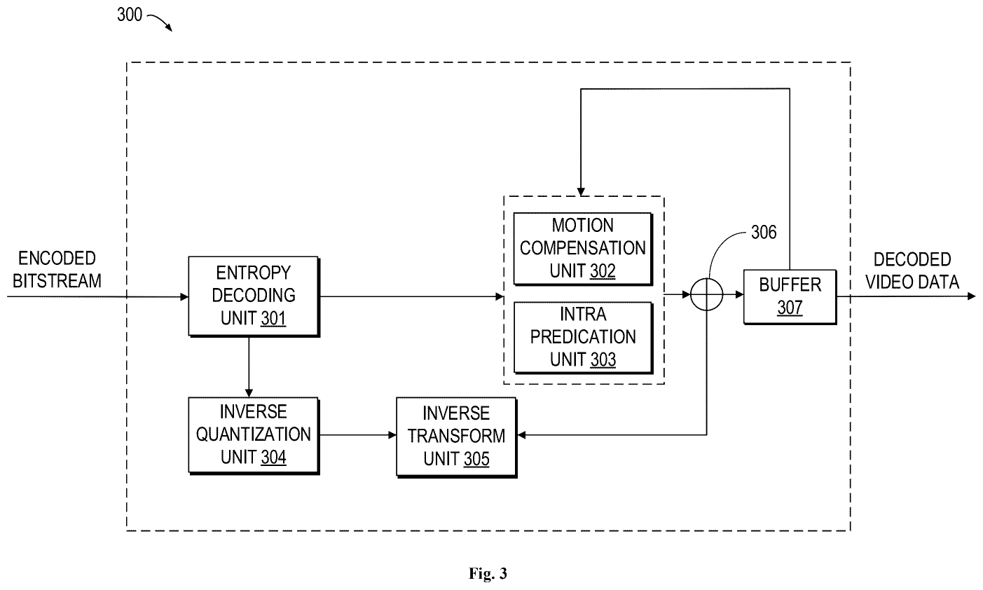

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to image/video coding technologies. Specifically, it is related to the definition and signaling of neural-network post-processing filtering purposes with various upsampling and enhancement, as well as their combinations. The ideas may be applied individually or in various combinations, for video bitstreams coded by any codec, e.g., the versatile video coding (VVC) standard and/or the versatile SEI messages for coded video bitstreams (VSEI) standard.

### 2. Abbreviations

APS Adaptation Parameter Set
AU Access Unit
CLVS Coded Layer Video Sequence
CLVSS Coded Layer Video Sequence Start
CRC Cyclic Redundancy Check
CVS Coded Video Sequence
FIR Finite Impulse Response
IRAP Intra Random Access Point
NAL Network Abstraction Layer
PPS Picture Parameter Set
PU Picture Unit
RASL Random Access Skipped Leading
SEI Supplemental Enhancement Information
STSA Step-wise Temporal Sublayer Access
VCL Video Coding Layer
VSEI versatile supplemental enhancement information (Rec. ITU-T H.274|ISO/IEC 23002-7)
VUI Video Usability Information
VVC versatile video coding (Rec. ITU-T H.266|ISO/IEC 23090-3)

### 3. Introduction

### 3.1. Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting at 50% bitrate reduction as compared to HEVC, that has been finalized by the JVET at its 19th meeting ended at Jul. 1, 2020.

The Versatile Video Coding (VVC) standard (ITU-T H.266|ISO/IEC 23090-3) and the associated Versatile Supplemental Enhancement Information for coded video bitstreams (VSEI) standard (ITU-T H.274|ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard that has recently been developed by MPEG.

### 3.2. SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.274|ISO/IEC 23002-7.

### 3.3. Signaling of Neural-Network Post-Filters

An excerpt from the specification of two SEI messages for signaling of neural-network post-filters is as follows.

### 4. Problems

The current design for the neural-network post-filter characteristics (NNPFC) SEI message has the following problems:
1) The value for the nnpfc_purpose syntax element is enumerated in an ad-hoc fashion, without a systematic structure. Such a design may make potential extensions of the value difficult and introduce potential instability and logical issues.
2) In an existing design, the following syntax table is related to purposes of neural-network post-filters.

| | De- |
|---|---|
| | scriptor |
| nn_post_filter_characteristics( payloadSize ) { | |
| nnpfc_{—}id | ue(v) |
| nnpfc_{—}mode_{—}idc | ue(v) |
| if( nnpfc_mode_idc = = 1 ) { | |
| while( !byte_aligned( ) ) | |
| nnpfc_{—}reserved_{—}zero_{—}bit_{—}a | u(1) |
| nnpfc_{—}tag_{—}uri | st(v) |
| nnpfc_{—}uri | st(v) |
| } | |
| nnpfc_{—}formatting_{—}and_{—}purpose_{—}flag | u(1) |
| if( nnpfc_formatting_and_purpose_flag ) { | |
| nnpfc_{—}purpose | ue(v) |
| /* input and output formatting */ | |
| if( nnpfc_purpose = = 2 \|\| nnpfc_purpose = = 4 ) | |
| nnpfc_{—}out_{—}sub_{—}c_{—}flag | u(1) |
| else if( nnpfc_purpose = = 3 \|\| nnpfc_purpose = = 4 ) { | |
| nnpfc_{—}pic_{—}width_{—}in_{—}luma_{—}samples | ue(v) |
| nnpfc_{—}pic_{—}height_{—}in_{—}luma_{—}samples | ue(v) |
| } | |
| else if( nnpfc_purpose = = 5 ) { | |
| nnpfc_{—}num_{—}input_{—}pics_{—}minus2 | ue(v) |
| for( i = 0; i <= nnpfc_num_input_pics_minus2; i++ ) | |
| nnpfc_{—}interpolated_{—}pics[ i ] | ue(v) |
| } | |
| ... ... | |

The description is verbose and also incorrect. For example, when nnpfc_purpose is 4, nnpfc_pic_width_in_luma_samples and nnpfc_pic_height_in_luma_samples will never be signaled, which is certainly problematic.

### 5. Detailed Solutions

To solve the above problems, methods as summarized below are disclosed. The solutions should be considered as examples to explain the general concepts and should not be interpreted in a narrow way. Furthermore, these solutions can be applied individually or combined in any manner.
1) To solve problem 1, instead of specifying the purpose, it is proposed to specify the format changes due to the neural-network post-filter.
   a. In one example, one primitive format change is colour format change.
      i. In one example, furthermore, only colour format change from a format with more chroma subsampling to a format with less chroma subsampling, e.g. 4:0:0 to 4:2:0, 4:2:0 to 4:2:2, is allowed.
      ii. Alternatively, furthermore, whether to signal the chroma format types (e.g., 4:2:0 to 4:2:2 or 4:2:0 to 4:4:4) may depend on whether a primitive format change represents colour format change.
   b. In one example, one primitive format change is picture resolution change.
      i. In one example, furthermore, only picture resolution change with increased width and/or height and/or size is allowed.
      ii. Alternatively, furthermore, whether to signal the resolution information may depend on whether a primitive format change represents picture resolution change.
   c. In one example, one primitive format change is frame rate change.
      i. In one example, furthermore, only frame rate change with increased frame rate is allowed.
      ii. Alternatively, furthermore, whether to signal the output frame rate information may depend on whether a primitive format change represents frame rate change.
   d. In one example, one primitive format change is bit-depth change.
      i. In one example, furthermore, only bit-depth change with increased bit-depth is allowed.
      ii. Alternatively, furthermore, whether to signal the output bit depth information may depend on whether a primitive format change represents bit-depth change.
   e. In one example, one format change is a combination of primitive format changes listed above.
   f. In one example, when there is no format change specified, it may be implicitly considered as visual quality improvement due to the neural-network post-filter.
   g. In one example, the format changes are indicated by one or more ue(v)-coded syntax elements.
   h. In one example, the format changes are indicated by one or more u(N)-coded syntax elements, where N is 3, 4, 6, 8, 10, 16, or 32.
2) To solve problem 1, bit masking methods, where one bit or effective bit may correspond to one kind of parameter change to support a purpose, may be used to represent different purposes or format changes and their combinations.
   a. In one example, a purpose or a format change is signaled as u(N), where each bit corresponds to a primitive format change or a primitive purpose, which means only one kind of parameter change is involved.
      i. In one example, N is 3, 4, 6, 8, 10, 16 or 32.
   b. In one example, a purpose or a format change is signaled using a value as ue(v), where each effective bit, i.e. bit corresponding to the binary representation of the value, corresponds to a primitive format change or a primitive purpose.
   c. In one example, when the certain bit is equal to 1, the corresponding format change happens.
      i. In one example, furthermore, when the certain bit is equal to 0, the corresponding format change does not happen.
3) To solve problem 2, instead of conditionally signaling format parameters by enumerating the purpose, whether to signal format parameters may depend on bit-masking operators of the format change or purpose.
   a. In one example, whether to signal format parameters is conditioned by if a certain bit or effective bit is 1 or 0.
4) A certain non-zero value of the syntax element to indicate format change may be used as determined by the application.
   a. In one example, the largest value in the valid range of the syntax element is used to indicate a filter purpose that may be used as determined by the application.

### 6. Embodiments

Below are some example embodiments for the solution aspects summarized above in Section 5.

Most relevant parts that have been added or modified are shown by using bolded words (e.g., this format indicates added text), and some of the deleted parts are shown by using words in italics between double curly brackets (e.g., {{this format indicates deleted text}}). There may be some other changes that are editorial in nature and thus not highlighted. It should be understood that only markings in this section are intended to emphasize at least part of proposed changes.

### 1. Embodiment 1

This embodiment is for solution item 1 and all its subitems summarized above in Section 5.

8.28.1 Neural-network post-filter characteristics SEI message syntax

| | Descriptor |
|---|---|
| nn_post_filter_characteristics( payloadSize ) { | |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| nnpfc_formatting_and_purpose_flag | u(1) |
| if( nnpfc_formatting_and_purpose_flag ) { | |
| {{nnpfc_{—}purpose}}nnpfc_{—}format_{—}change_{—}type | ue(v) |
| /* input and output formatting */ | |
| if( nnpfc_{—}format_{—}change_{—}type & 0x01 != 0 {{nnpfc_{—}purpose = = 2 \|\| | |
| nnpfc_{—}purpose = = 4}} ) | |
| nnpfc_out_sub_c_flag | u(1) |
| {{else}} if( nnpfc_{—}format_{—}change_{—}type & 0x02 != 0 {{nnpfc_{—}purpose = = 3 \| \| | |
| nnpfc_{—}purpose = = 4}} ) { | |
| nnpfc_pic_width_in_luma_samples | ue(v) |
| nnpfc_pic_height_in_luma_samples | ue(v) |
| } | |
| {{else}} if( nnpfc_{—}format_{—}change_{—}type & 0x04 != 0 | |
| {{nnpfc_{—}purpose = = 5}} ) | |
| { | |
| nnpfc_num_input_pics_minus2 | ue(v) |
| for( i = 0; i <= nnpfc_num_input_pics_minus2; i++ ) | |
| nnpfc_interpolated_pics[ i ] | ue(v) |
| } | |
| ... | |

8.28.2 Neural-network post-filter characteristics SEI message semantics
{{nnpfc_{—}purpose indicates the purpose of the post-processing filter as specified in Table 20.
The value of nnpfc_{—}purpose shall be in the range of 0 to 5, inclusive, in bitstreams conforming to this
edition of this document. Values of 6 to 1023, inclusive, for nnpfc_{—}purpose are reserved for future use by
ITU-T | ISO/IEC and shall not be present in bitstreams conforming to this edition of this document.
Decoders conforming to this edition of this document shall ignore NNPFC SEI messages with
nnpfc_{—}purpose in the range of 6 to 1203, inclusive. Values of nnpfc_{—}purpose greater than 1023 shall not
be present in bitstreams conforming to this edition of this document and are not reserved for future use.

Table 20 - Definition of nnpfc_{—}purpose}}

| {{Value}} | {{Interpretation}} |
|---|---|
| {{0}} | {{May be used as determined by the application}} |
| {{1}} | {{Visual quality improvement}} |
| {{2}} | {{Chroma upsampling from the 4:2:0 chroma format to the |
| | 4:2:2 or 4:4:4 chroma format, or from the 4:2:2 chroma format |
| | to the 4:4:4 chroma format}} |
| {{3}} | {{Increasing the width or height of the cropped decoded |
| | output picture without changing the chroma format}} |
| {{4}} | {{Increasing the width or height of the cropped decoded |
| | output picture and upsampling the chroma format}} |
| {{5}} | {{Picture rate upsampling}} |

{{
NOTE 3- When a reserved value of nnpfc_{—}purpose is taken into use in the future by ITU-T | ISO/IEC,
the syntax of this SEI message could be extended with syntax elements whose presence is conditioned
by nnpfc_{—}purpose being equal to that value.
When SubWidthC is equal to 1 and SubHeightC is equal to 1, nnpfc_{—}purpose shall not be equal to 2 or 4. }}
nnpfc_{—}format_{—}change_{—}type indicates whether a certain format change exists due to the post-
processing filter as specificed in Table 20.
The value of nnpfc_{—}format_{—}change_{—}type shall be in the range of 0 to 7, inclusive, in bitstreams
conforming to this edition of this document. Values of 8 to 1023, inclusive, for nnpfc_{—}purpose are
reserved for future use by ITU-T | ISO/IEC and shall not be present in bitstreams conforming to this
edition of this document. Decoders conforming to this edition of this document shall ignore NNPFC
SEI messages with nnpfc_{—}purpose in the range of 8 to 1203, inclusive. Values of nnpfc_{—}purpose
greater than 1023 shall not be present in bitstreams conforming to this edition of this document and
are not reserved for future use.
When no format change exists, the post-processing filter may be for the purpose of visual quality
improvement.

Table 20 - Definition of nnpfc_{—}format_{—}change_{—}type

| Condition | Interpretation |
|---|---|
| nnpfc_{—}format_{—}change_{—}type & | Chroma upsampling (from the 4:2:0 chroma format to the |
| 0x01 != 0 | 4:2:2 or 4:4:4 chroma format, or from the 4:2:2 chroma |
| | format to the 4:4:4 chroma format) |
| nnpfc_{—}format_{—}change_{—}type & | Resolution upsampling (increasing the width or height of |
| 0x02 != 0 | the cropped decoded output picture) |
| nnpfc_{—}format_{—}change_{—}type & | Picture rate upsampling |

0x04 != 0
When SubWidthC is equal to 1 and SubHeightC is equal to 1, nnpfc_{—}format_{—}change_{—}type & 0x01
shall be 0.

### 2. Embodiment 2

This embodiment is for solution item 2 and all its subitems summarized above in Section 5.

8.28.1 Neural-network post-filter characteristics SEI message syntax

| | Descriptor |
|---|---|
| nn_post_filter_characteristics( payloadSize ) { | |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| nnpfc_formatting_and_purpose_flag | u(1) |
| if( nnpfc_formatting_and_purpose_flag ) { | |
| nnpfc_purpose | ue(v) |
| /* input and output formatting */ | |
| if( nnpfc_purpose & 0x01 != 0 {{ = = 2 \|\| | |
| nnpfc_{—}purpose = = 4}} ) | |
| nnpfc_out_sub_c_flag | u(1) |
| else if( nnpfc_purpose & 0x02 != 0 {{= = 3 \| \| | |
| nnpfc_{—}purpose = = 4}} ) { | |
| nnpfc_pic_width_in_luma_samples | ue(v) |
| nnpfc_pic_height_in_luma_samples | ue(v) |
| } | |
| else if( nnpfc_purpose & 0x04 != 0 {{= = 5}} ) { | |
| nnpfc_num_input_pics_minus2 | ue(v) |
| for( i = 0; i <= nnpfc_num_input_pics_minus2; i++ ) | |
| nnpfc_interpolated_pics[ i ] | ue(v) |
| } | |

8.28.2 Neural-network post-filter characteristics SEI message semantics
nnpfc_purpose indicates the purpose of the post-processing filter as specified in Table 20.
The value of nnpfc_purpose shall be in the range of 0 to {{5}}7, inclusive, in bitstreams conforming to this
edition of this document. Values of {{6}}8 to 1023, inclusive, for nnpfc_purpose are reserved for future use
by ITU-T | ISO/IEC and shall not be present in bitstreams conforming to this edition of this document.
Decoders conforming to this edition of this document shall ignore NNPFC SEI messages with
nnpfc_purpose in the range of {{6}}8 to 1203, inclusive. Values of nnpfc_purpose greater than 1023 shall
not be present in bitstreams conforming to this edition of this document and are not reserved for future use.

{{Table 20 - Definition of nnpfc_{—}purpose}}

| {{Value}} | {{Interpretation}} |
|---|---|
| {{0}} | {{May be used as determined by the application}} |
| {{1}} | {{Visual quality improvement}} |
| {{2}} | {{Chroma upsampling from the 4:2:0 chroma format to the 4:2:2 |
| | or 4:4:4 chroma format, or from the 4:2:2 chroma format to the 4:4:4 |
| | chroma format}} |
| {{3}} | {{Increasing the width or height of the cropped decoded output |
| | picture without changing the chroma format}} |
| {{4}} | {{Increasing the width or height of the cropped decoded output |
| | picture and upsampling the chroma format}} |
| {{5}} | {{Picture rate upsampling}} |

Table 20 - Definition of nnpfc_{—}purpose

| Value | Interpretation |
|---|---|
| 0 | Visual quality improvement without format change |
| 1 | Chroma upsampling from the 4:2:0 chroma format to the 4:2:2 or 4:4:4 chroma |
| | format, or from the 4:2:2 chroma format to the 4:4:4 chroma format |
| 2 | Increasing the width or height of the cropped decoded output picture |
| 3 | Increasing the width or height of the cropped decoded output picture |
| | and upsampling the chroma format |
| 4 | Picture rate upsampling |
| 5 | Picture rate upsampling and upsampling the chroma format |
| 6 | Picture rate upsampling and increasing the width or height of the cropped |
| | decoded output picture |
| 7 | Picture rate upsampling, increasing the width or height of the cropped |
| | decoded output picture and upsampling the chroma format |

NOTE 3- When a reserved value of nnpfc_purpose is taken into use in the future by ITU-T | ISO/IEC,
the syntax of this SEI message could be extended with syntax elements whose presence is conditioned
by nnpfc_purpose being equal to that value.

### 3. Embodiment 3

This embodiment is for solution item 3 and all its subitems summarized above in Section 5.

8.28.1 Neural-network post-filter characteristics SEI message syntax

| | Descriptor |
|---|---|
| nn_post_filter_characteristics( payloadSize ) { | |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| nnpfc_formatting_and_purpose_flag | u(1) |
| if( nnpfc_formatting_and_purpose_flag ) { | |
| nnpfc_purpose | ue(v) |
| /* input and output formatting */ | |
| if( nnpfc_purpose & 0x01 != 0 {{= = 2 \|\| | |
| nnpfc_{—}purpose = = 4}} ) | |
| nnpfc_out_sub_c_flag | u(1) |
| {{else }}if( nnpfc_purpose & 0x02 != 0 {{= = 3 \| \| | |
| nnpfc_{—}purpose = = 4}} ) { | |
| nnpfc_pic_width_in_luma_samples | ue(v) |
| nnpfc_pic_height_in_luma_samples | ue(v) |
| } | |
| {{else }}if( nnpfc_purpose & 0x04 != 0 {{= = 5}} ) { | |
| nnpfc_num_input_pics_minus2 | ue(v) |
| for( i = 0; i <= nnpfc_num_input_pics_minus2; i++ ) | |
| nnpfc_interpolated_pics[ i ] | ue(v) |
| } | |

8.28.2 Neural-network post-filter characteristics SEI message semantics
nnpfc_purpose indicates the purpose of the post-processing filter as specified in Table 20.
The value of nnpfc_purpose shall be in the range of 0 to {{5}}7, inclusive, in bitstreams conforming to this
edition of this document. Values of {{6}}8 to 1023, inclusive, for nnpfc_purpose are reserved for future use
by ITU-T | ISO/IEC and shall not be present in bitstreams conforming to this edition of this document.
Decoders conforming to this edition of this document shall ignore NNPFC SEI messages with
nnpfc_purpose in the range of {{6}}8 to 1203, inclusive. Values of nnpfc_purpose greater than 1023 shall
not be present in bitstreams conforming to this edition of this document and are not reserved for future use.

{{Table 20 - Definition of nnpfc_{—}purpose}}

| {{Value}} | {{Interpretation}} |
|---|---|
| {{0}} | {{May be used as determined by the application}} |
| {{1}} | {{Visual quality improvement}} |
| {{2}} | {{Chroma upsampling from the 4:2:0 chroma format to the 4:2:2 or 4:4:4 |
| {{3}} | chroma format, or from the 4:2:2 chroma format to the 4:4:4 chroma format}} |
| | {{Increasing the width or height of the cropped decoded output picture |
| | without changing the chroma format}} |
| {{4}} | {{Increasing the width or height of the cropped decoded output picture |
| | and upsampling the chroma format}} |
| {{5}} | {{Picture rate upsampling}} |

Table 20 - Definition of nnpfc_{—}purpose

| Value | Interpretation |
|---|---|
| 0 | Visual quality improvement without format change |
| 1 | Chroma upsampling from the 4:2:0 chroma format to the 4:2:2 or 4:4:4 chroma |
| | format, or from the 4:2:2 chroma format to the 4:4:4 chroma format |
| 2 | Increasing the width or height of the cropped decoded output picture |
| 3 | Increasing the width or height of the cropped decoded output picture and |
| | upsampling the chroma format |
| 4 | Picture rate upsampling |
| 5 | Picture rate upsampling and upsampling the chroma format |
| 6 | Picture rate upsampling and increasing the width or height of the cropped |
| | decoded output picture |
| 7 | Picture rate upsampling, increasing the width or height of the cropped |
| | decoded output picture and upsampling the chroma format |

NOTE 3- When a reserved value of nnpfc_purpose is taken into use in the future by ITU-T | ISO/IEC,
the syntax of this SEI message could be extended with syntax elements whose presence is conditioned
by nnpfc_purpose being equal to that value.

### 4. Embodiment 4

This embodiment is for solution item 2 and item 3 and all their subitems summarized above in Section 5.

8.28.1 Neural-network post-filter characteristics SEI message syntax

| | Descriptor |
|---|---|
| nn_post_filter_characteristics( payloadSize ) { | |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| nnpfc_formatting_and_purpose_flag | u(1) |
| if( nnpfc_formatting_and_purpose_flag ) { | |
| nnpfc_purpose | ue(v) |
| /* input and output formatting */ | |
| if( nnpfc_purpose & 0x02 != 0 {{= = 2 \|\| | |
| nnpfc_{—}purpose = = 4}} ) | |
| nnpfc_out_sub_c_flag | u(1) |
| {{else }}if( nnpfc_purpose & 0x04 != 0 {{= = 3 | |
| \|\| nnpfc_{—}purpose = = 4}} ) { | |
| nnpfc_pic_width_in_luma_samples | ue(v) |
| nnpfc_pic_height_in_luma_samples | ue(v) |
| } | |
| {{else }}if( nnpfc_purpose & 0x08 != 0 {{= = 5}} ) { | |
| nnpfc_num_input_pics_minus2 | ue(v) |
| for( i = 0; i <= nnpfc_num_input_pics_minus2; i++ ) | |
| nnpfc_interpolated_pics[ i ] | ue(v) |
| } | |

8.28.2 Neural-network post-filter characteristics SEI message semantics
nnpfc_purpose indicates the purpose of the post-processing filter as specified in Table 20.
The value of nnpfc_purpose shall be in the range of 0 to {{5}}7, inclusive, in bitstreams conforming to this
edition of this document. Values of {{6}}8 to 1023, inclusive, for nnpfc_purpose are reserved for future use
by ITU-T | ISO/IEC and shall not be present in bitstreams conforming to this edition of this document.
Decoders conforming to this edition of this document shall ignore NNPFC SEI messages with
nnpfc_purpose in the range of {{6}}8 to 1203, inclusive. Values of nnpfc_purpose greater than 1023 shall
not be present in bitstreams conforming to this edition of this document and are not reserved for future use.

{{Table 20 - Definition of nnpfc_{—}purpose}}

| {{Value}} | {{Interpretation}} |
|---|---|
| {{0}} | {{May be used as determined by the application}} |
| {{1}} | {{Visual quality improvement}} |
| {{2}} | {{Chroma upsampling from the 4:2:0 chroma format to |
| | the 4:2:2 or 4:4:4 chroma format, or from the 4:2:2 chroma |
| | format to the 4:4:4 chroma format}} |
| {{3}} | {{Increasing the width or height of the cropped |
| | decoded output picture without changing the chroma format}} |
| {{4}} | {{Increasing the width or height of the cropped |
| | decoded output picture and upsampling the chroma format}} |
| {{5}} | {{Picture rate upsampling}} |

Table 20 - Definition of nnpfc_{—}purpose

| Value | Interpretation |
|---|---|
| 0 | May be used as determined by the application |
| 1 | Visual quality improvement |
| nnpfc_{—}purpose & 0x02 != | Chroma upsampling (from the 4:2:0 chroma format to the 4:2:2 or |
| 0 | 4:4:4 chroma format, or from the 4:2:2 chroma format to the 4:4:4 |
| | chroma format) |
| nnpfc_{—}purpose & 0x04 != | Resolution upsampling (increasing the width or height of the |
| 0 | cropped decoded output picture) |
| nnpfc_{—}purpose & 0x08 != | Picture rate upsampling |
| 0 | |

NOTE 3- When a reserved value of nnpfc_purpose is taken into use in the future by ITU-T | ISO/IEC,
the syntax of this SEI message could be extended with syntax elements whose presence is conditioned
by nnpfc_purpose being equal to that value.

### 5. Embodiment 5

8.28.1 Neural-network post-filter characteristics SEI message syntax

| | Descriptor |
|---|---|
| nn_post_filter_characteristics( payloadSize ) { | |
| ... | |
| if( nnpfc_formatting_and_purpose_flag ) { | |
| nnpfc_purpose | {{ue(v)}} |
| | u(10) |
| /* input and output formatting */ | |
| {{if( nnpfc_{—}purpose = = 2 \|\| nnpfc_{—}purpose = = 4 ) }} | |
| if( nnpfc_{—}purpose & 0x01 != 0 ) | |
| nnpfc_out_sub_c_flag | u(1) |
| {{else if( nnpfc_{—}purpose = = 3 \|\| nnpfc_{—}purpose = = 4 ) { }} | |
| if( nnpfc_{—}purpose & 0x02 != 0 ) { | |
| nnpfc_pic_width_in_luma_samples | ue(v) |
| nnpfc_pic_height_in_luma_samples | ue(v) |
| } | |
| {{else if( nnpfc_{—}purpose = = 5 ) { }} | |
| if( nnpfc_{—}purpose & 0x04 != 0 ) { | |
| nnpfc_num_input_pics_minus2 | ue(v) |
| for( i = 0; i <= nnpfc_num_input_pics_minus2; i++ ) | |
| nnpfc_interpolated_pics [ i ] | ue(v) |
| } | |
| ... | |

8.28.2 Neural-network post-filter characteristics SEI message semantics
nnpfc_purpose indicates the purpose of the post-processing filter as specified in Table 20.
The value of nnpfc_purpose shall be in the range of 0 to {{5}} 7, inclusive, or equal to 1023 in bitstreams
conforming to this edition of this document. Values of {{6}} 8 to {{1023}} 1022, inclusive, for
nnpfc_purpose are reserved for future use by ITU-T | ISO/IEC and shall not be present in bitstreams
conforming to this edition of this document. Decoders conforming to this edition of this document shall
ignore NNPFC SEI messages with nnpfc_purpose in the range of {{6}} 8 to {{1203}} 1022, inclusive.
Values of nnpfc_purpose greater than 1023 shall not be present in bitstreams conforming to this edition of
this document and are not reserved for future use.
When no format change exists, the post-processing filter may be for the purpose of visual quality
improvement.

{{Table 20 - Definition of nnpfc_{—}purpose}}

| {{Value}} | {{Interpretation}} |
|---|---|
| {{0}} | {{May be used as determined by the application}} |
| {{1}} | {{Visual quality improvement}} |
| {{2}} | {{Chroma upsampling from the 4:2:0 chroma format to the 4:2:2 or 4:4:4 |
| | chroma format, or from the 4:2:2 chroma format to the 4:4:4 chroma format}} |
| {{3}} | {{Increasing the width or height of the cropped decoded output picture |
| | without changing the chroma format} } |
| {{4}} | {{Increasing the width or height of the cropped decoded output picture |
| | and upsampling the chroma format}} |
| {{5}} | {{Picture rate upsampling}} |

0L - Definition of nnpfc_{—}purpose

| Value | Interpretation |
|---|---|
| nnpfc_{—}purpose & 0x01 != | No chroma upsampling |
| 0 | |
| nnpfc_{—}purpose & 0x01 != | Chroma upsampling (from the 4:2:0 chroma format to the 4:2:2 or |
| 0 | 4:4:4 chroma format, or from the 4:2:2 chroma format to the 4:4:4 |
| | chroma format) |
| nnpfc_{—}purpose & 0x02 = = | No resolution upsampling |
| 0 | |
| nnpfc_{—}purpose & 0x02 != | Resolution upsampling (increasing the width or height of the |
| 0 | cropped decoded output picture) |
| nnpfc_{—}purpose & 0x04 = = | No picture rate upsampling |
| 0 | |
| nnpfc_{—}purpose & 0x04 != | Picture rate upsampling |
| 0 | |
| nnpfc_{—}purpose = = 1023 | May be used as determined by the application |

### 6. Embodiment 6

8.28.1 Neural-network post-filter characteristics SEI message syntax

| | Descriptor |
|---|---|
| nn_post_filter_characteristics( payloadSize ) { | |
| ... | |
| if( nnpfc_formatting_and_purpose_flag ) { | |
| nnpfc_purpose | ue(v) |
| /* input and output formatting */ | |
| {{if( nnpfc_{—}purpose = = 2 \|\| nnpfc_{—}purpose = = 4 ) }} | |
| if( nnpfc_{—}purpose & 0x01 != 0 ) | |
| nnpfc_out_sub_c_flag | u(1) |
| {{else if( npfc_{—}purpose = = 3 \|\| nnpfc_{—}purpose = = 4 ) }} | |
| if( nnpfc_{—}purpose & 0x02 != 0 ) { | |
| nnpfc_pic_width_in_luma_samples | ue(v) |
| nnpfc_pic_height_in_luma_samples | ue(v) |
| } | |
| {{else if( nnpfc_{—}purpose = = 5 ) { }} | |
| if( nnpfc_{—}purpose & 0x04 != 0 ) { | |
| nnpfc_num_input_pics_minus2 | ue(v) |
| for( i = 0; i <= nnpfc_num_input_pics_minus2; i++ ) | |
| nnpfc_interpolated_pics[ i ] | ue(v) |
| } | |
| ... | |

8.28.2 Neural-network post-filter characteristics SEI message semantics
nnpfc_purpose indicates the purpose of the post-processing filter as specified in Table 20.
The value of nnpfc_purpose shall be in the range of 0 to {{5}} 7, inclusive, or equal to 1023 in bitstreams
conforming to this edition of this document. Values of {{6}} 8 to {{1023}} 1022, inclusive, for
nnpfc_purpose are reserved for future use by ITU-T | ISO/IEC and shall not be present in bitstreams
conforming to this edition of this document. Decoders conforming to this edition of this document shall
ignore NNPFC SEI messages with nnpfc_purpose in the range of {{6}} 8 to {{1203}} 1022, inclusive.
Values of nnpfc_purpose greater than 1023 shall not be present in bitstreams conforming to this edition
of this document and are not reserved for future use.
When no format change exists, the post-processing filter may be for the purpose of visual quality
improvement.

{{Table 20 - Definition of nnpfc_{—}purpose}}

| {{Value}} | {{Interpretation}} |
|---|---|
| {{0}} | {{May be used as determined by the application}} |
| {{1}} | {{Visual quality improvement}} |
| {{2}} | {{Chroma upsampling from the 4:2:0 chroma format to the 4:2:2 |
| | or 4:4:4 chroma format, or from the 4:2:2 chroma format to the 4:4:4 |
| | chroma format}} |
| {{3}} | {{Increasing the width or height of the cropped decoded output |
| | picture without changing the chroma format}} |
| {{4}} | {{Increasing the width or height of the cropped decoded output |
| | picture and upsampling the chroma format}} |
| {{5}} | {{Picture rate upsampling}} |

Table 20 - Definition of nnpfc_{—}purpose

| Value | Interpretation |
|---|---|
| nnpfc_{—}purpose & 0x01 = = | No chroma upsampling |
| 0 | |
| nnpfc_{—}purpose & 0x01 != | Chroma upsampling (from the 4:2:0 chroma format to the 4:2:2 or |
| 0 | 4:4:4 chroma format, or from the 4:2:2 chroma format to the 4:4:4 |
| | chroma format) |
| nnpfc_{—}purpose & 0x02 = = | No resolution upsampling |
| 0 | |
| nnpfc_{—}purpose & 0x02 != | Resolution upsampling (increasing the width or height of the |
| 0 | cropped decoded output picture) |
| nnpfc_{—}purpose & 0x04 = = | No picture rate upsampling |
| 0 | |
| nnpfc_{—}purpose & 0x04 != | Picture rate upsampling |
| 0 | |
| nnpfc_{—}purpose = = 1023 | May be used as determined by the application |

More details of the embodiments of the present disclosure will be described below which are related to neural-network post-processing filter. As used herein, the term “neural-network post-processing filter” and “neural-network post-filter” may be used interchangeably. The embodiments of the present disclosure should be considered as examples to explain the general concepts and should not be interpreted in a narrow way. Furthermore, these embodiments can be applied individually or combined in any manner.

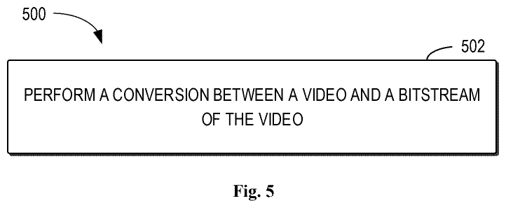

FIG. 5 illustrates a flowchart of a method 500 for video processing in accordance with some embodiments of the present disclosure. As shown in FIG. 5, at 502, a conversion between a video and a bitstream of the video is performed. In some embodiments, the conversion may include encoding the video into the bitstream. Alternatively or additionally, the conversion may include decoding the video from the bitstream.

A neural-network post-processing filter (NNPF) is applied on at least one picture associated with the video. For example, the at least one picture may be used as an input for the NNPF. In some embodiments, the at least one picture may comprise at least one decoded picture of the video. Alternatively, the at least one picture may comprise at least one cropped decoded picture of the video. For example, the decoded picture and/or the cropped decoded picture may be outputted by a decoder that decodes the video from the bitstream. In some further embodiments, the at least one picture may comprise an output of a further NNPF used to filter one or more decoded pictures or cropped decoded pictures of the video. For example, the NNPF is concatenated with the further NNPF. It should be understood that the possible implementations of the at least one picture associated with the video described here are merely illustrative and therefore should not be construed as limiting the present disclosure in any way.

The bitstream comprises a first indication indicating a purpose of the NNPF. By way of example, the first indication may be comprised in a supplemental enhancement information (SEI) message or any other suitable video message unit in the bitstream. For example, the first indication may comprise a syntax element nnpfc_purpose. It should be understood that the name for an indication and/or a syntax element is used only for illustration rather than limitation, the indication(s) and the syntax element(s) mentioned throughout the present disclosure may be represented by any other suitable string different from that mentioned in this disclosure. The scope of the present disclosure is not limited in this respect.

Moreover, one of a plurality of candidates for the purpose corresponds to a bit mask. The bit mask is used for determining the purpose of the NNPF based on the first indication. By way of example rather than limitation, one bit or one effective bit in the first indication may indicate whether the purpose of the NNPF comprises one of the plurality of candidates for the purpose. In this case, one bit or one effective bit in the first indication corresponds to one candidate for the purpose. In some further embodiments, more than one bit or more than one effective bit in the first indication may correspond to one candidate for the purpose.

For example, if a value of a first bit (such as bit 0, bit 1 or the like) in the first indication is equal to a first value (such as 1 or the like), the purpose of the NNPF may comprise a first candidate (such as chroma upsampling, resolution resampling, or the like) in the plurality of candidates for the purpose. If the value of the first bit is equal to a second value (such as 0 or the like), the purpose of the NNPF may do not comprise the first candidate for the purpose.

In some embodiments, the purpose of the NNPF may be determined based on the first indication and at least one bit mask, that is used for determining the purpose of the NNPF based on the first indication. For example, the purpose of the NNPF may be determined by applying a bitwise operation on the first indication and the at least one bit mask. By way of example rather than limitation, bit 0 may represent the least significant bit in a syntax element nnpfc_purpose, while bit 1 in the syntax element nnpfc_purpose may correspond to chroma upsampling. A bit mask 0x02 may be used for determining whether the purpose of the NNPF comprises chroma upsampling. If (nnpfc_purpose & 0x02) is equal to 0, the purpose of the NNPF does not comprise chroma upsampling. If (nnpfc_purpose & 0x02) is larger than 0, the purpose of the NNPF comprises chroma upsampling. The operator “&” represents a bitwise AND operation. It should be understood that the above illustrations are described merely for purpose of description. The scope of the present disclosure is not limited in this respect.

In view of the above, one of the plurality of candidates for the purpose of the NNPF corresponds to a bit mask that is used for determining the purpose of the NNPF based on the first indication. Compared with the conventional solution, the proposed method advantageously provides a systematic scheme for signaling the purpose of the NNPF, and thus supports a possible extension of the purpose. Thereby, potential instability and logical issues can be avoided, and the coding efficiency can be improved.

In some embodiments, the first indication may be indicated as an unsigned integer using a plurality of bits, while the number of the plurality of bits may be 3, 4, 6, 8, 10, 16, 32, or any other suitable integer. For example, each of the plurality of bits may correspond to one of the plurality of candidates for the purpose. In some alternative embodiments, the first indication may be indicated as an unsigned integer 0-th order Exponential-Golomb-coded syntax element. For example, each effective bit in the first indication may correspond to one of the plurality of candidates for the purpose. An effective bit may refer to a bit corresponding to a binary representation of the value.

In some embodiments, whether at least one format parameter for a filtering process using the NNPF is indicated in the bitstream is dependent on a result of applying a bitwise operation on the first indication and the at least one bit mask. Alternatively, whether at least one format parameter for a filtering process using the NNPF is indicated in the bitstream may be dependent on a value of a bit or an effective bit in the first indication. Thereby, potential instability and logical issues can be avoided, and the coding efficiency can be improved.

In one example embodiment, if (nnpfc_purpose & 0x02) is larger than 0, it is determined that the purpose of the NNPF comprises chroma upsampling. In a case where the purpose of the NNPF comprises chroma upsampling, information regarding a chroma format of an output of the NNPF may be indicated by a syntax element in the bitstream. In a further example embodiment, if (nnpfc_purpose & 0x04) is larger than 0, it is determined that the purpose of the NNPF comprises resolution resampling. In a case where the purpose of the NNPF comprises resolution resampling, information regarding a resolution of an output of the NNPF may be indicated by a syntax element in the bitstream.

In some embodiments, the plurality of candidates for the purpose of the NNPF may comprise a change of a format of the at least one picture. In one example embodiment, the plurality of candidates for the purpose of the NNPF may comprise a change of a color format of the at least one picture. For example, the change of the color format may comprise a change from the color format to a further color format with a chroma subsampling rate less than a chroma subsampling rate of the color format, such as a change from 4:0:0 format to 4:2:0 format, a change from 4:2:0 format to 4:2:2 format or the like. Whether a color format type is indicated in the bitstream may be dependent on whether the purpose of the NNPF comprises the change of the color format. By way of example rather than limitation, the color format type is indicated in the bitstream only when the purpose of the NNPF comprises the change of the color format.

In another example embodiment, the plurality of candidates for the purpose of the NNPF may comprise a change of a picture resolution of the at least one picture. For example, the change of the picture resolution may comprise an increase of the picture resolution. Whether resolution information is indicated in the bitstream may be dependent on whether the purpose of the NNPF comprises the change of the picture resolution. By way of example rather than limitation, the resolution information is indicated in the bitstream only when the purpose of the NNPF comprises the change of the picture resolution.

In a further example embodiment, the plurality of candidates for the purpose of the NNPF may comprise a change of a picture rate of the at least one picture. For example, the change of the picture rate may comprise an increase of the picture rate. Whether output picture rate information is indicated in the bitstream may be dependent on whether the purpose of the NNPF comprises the change of the picture rate. By way of example rather than limitation, the output picture rate information is indicated in the bitstream only when the purpose of the NNPF comprises the change of the picture rate.

In some embodiments, the plurality of candidates for the purpose of the NNPF may comprise a change of a bit depth of a sample value in the at least one picture. For example, the change of the bit depth may comprise an increase of the bit depth. Whether output bit depth information is indicated in the bitstream may be dependent on whether the purpose of the NNPF comprises the change of the bit depth. By way of example rather than limitation, the output bit depth information is indicated in the bitstream only when the purpose of the NNPF comprises the change of the bit depth.

As described above, each of the change of the color format, the change of a picture resolution, the change of the picture rate, and the change of the bit depth may be regard as a candidate for the purpose of the NNPF, which may also be referred to as a primitive format change or a primitive purpose, since only one kind of parameter change is involved. It should be understood that the plurality of candidates for the purpose of the NNPF may also comprise any other suitable process, such as colorization of the input of the NNPF, improve of visual quality, and/or the like. The scope of the present disclosure is not limited in this respect.

In some embodiments, the purpose of the NNPF may comprise a combination of a plurality of candidates for the purpose. For example, the purpose of the NNPF may be allowed to comprise a combination of at least two of the following: a change of a color format of the at least one picture, a change of a picture resolution of the at least one picture, a change of a picture rate of the at least one picture, or a change of a bit depth of a sample value in the at least one picture.

In some embodiments, if the first indication indicates that the purpose of the NNPF does not comprise a change of a format of the at least one picture, the purpose of the NNPF may comprise an improvement of visual quality of the at least one picture. For example, when there is no format change specified, it may be implicitly considered as visual quality improvement due to the neural-network post-filter.

In some embodiments, the change of the format of the at least one picture may be indicated by one or more unsigned integer 0-th order Exponential-Golomb-coded syntax elements. Alternatively, the change of the format of the at least one picture may be indicated by one or more unsigned integer syntax elements using N bits, where N may be an integer, such as 3, 4, 6, 8, 10, 16, or 32.

In some embodiments, a non-zero value of the first indication may indicate that the NNPF is used as determined by an application. For example, the non-zero value may be the largest value in a valid range of the first indication. By way of example, in a case where a valid range of the first indication is from 0 to 1023, inclusive, a value of the first indication equal to 1023 indicates the NNPF is used as determined by an application. It should be understood that the specific values recited herein are intended to be exemplary rather than limiting the scope of the present disclosure.

In view of the above, the solutions in accordance with some embodiments of the present disclosure can advantageously avoid potential instability and logical issues, and thus the coding efficiency can be improved.

According to further embodiments of the present disclosure, a non-transitory computer-readable recording medium is provided. The non-transitory computer-readable recording medium stores a bitstream of a video which is generated by a method performed by an apparatus for video processing. In the method, the conversion between the video and the bitstream, wherein a neural-network post-processing filter (NNPF) is applied on at least one picture associated with the video. The bitstream comprises a first indication indicating a purpose of the NNPF. One of a plurality of candidates for the purpose corresponds to a bit mask, and the bit mask is used for determining the purpose of the NNPF based on the first indication.

According to still further embodiments of the present disclosure, a method for storing bitstream of a video is provided. In the method, the conversion between the video and the bitstream, wherein a neural-network post-processing filter (NNPF) is applied on at least one picture associated with the video. The bitstream comprises a first indication indicating a purpose of the NNPF. One of a plurality of candidates for the purpose corresponds to a bit mask, and the bit mask is used for determining the purpose of the NNPF based on the first indication. Moreover, the bitstream is stored in a non-transitory computer-readable recording medium.

Implementations of the present disclosure can be described in view of the following clauses, the features of which can be combined in any reasonable manner.

Clause 1. A method for video processing, comprising: performing a conversion between a video and a bitstream of the video, wherein a neural-network post-processing filter (NNPF) is applied on at least one picture associated with the video, the bitstream comprises a first indication indicating a purpose of the NNPF, one of a plurality of candidates for the purpose corresponds to a bit mask, and the bit mask is used for determining the purpose of the NNPF based on the first indication.

Clause 2. The method of clause 1, wherein one bit or one effective bit in the first indication indicates whether the purpose of the NNPF comprises one of the plurality of candidates for the purpose.

Clause 3. The method of any of clauses 1-2, wherein the first indication comprises a syntax element nnpfc_purpose.

Clause 4. The method of any of clauses 1-3, wherein the first indication is indicated as an unsigned integer using a plurality of bits.

Clause 5. The method of clause 4, wherein the number of the plurality of bits is one of 3, 4, 6, 8, 10, 16 or 32.

Clause 6. The method of any of clauses 1-5, wherein if a value of a first bit in the first indication is equal to a first value, the purpose of the NNPF comprises a first candidate in the plurality of candidates for the purpose, or if the value of the first bit is equal to a second value, the purpose of the NNPF does not comprise the first candidate for the purpose.

Clause 7. The method of clause 6, wherein the first value of 1, or the second value is 0.

Clause 8. The method of any of clauses 1-7, wherein whether at least one format parameter for a filtering process using the NNPF is indicated in the bitstream is dependent on a result of applying a bitwise operation on the first indication and at least one bit mask, and the at least one bit mask is used for determining the purpose of the NNPF based on the first indication.

Clause 9. The method of any of clauses 1-7, wherein whether at least one format parameter for a filtering process using the NNPF is indicated in the bitstream is dependent on a value of a bit or an effective bit in the first indication.

Clause 10. The method of any of clauses 1-9, wherein the plurality of candidates for the purpose comprise a change of a format of the at least one picture.

Clause 11. The method of any of clauses 1-10, wherein the plurality of candidates for the purpose comprise a change of a color format of the at least one picture.

Clause 12. The method of clause 11, wherein the change of the color format comprises a change from the color format to a further color format with a chroma subsampling rate less than a chroma subsampling rate of the color format.

Clause 13. The method of any of clauses 11-12, wherein whether a color format type is indicated in the bitstream is dependent on whether the purpose of the NNPF comprises the change of the color format.

Clause 14. The method of any of clauses 1-13, wherein the plurality of candidates for the purpose comprise a change of a picture resolution of the at least one picture.

Clause 15. The method of clause 14, wherein the change of the picture resolution comprises an increase of the picture resolution.

Clause 16. The method of any of clauses 14-15, wherein whether resolution information is indicated in the bitstream is dependent on whether the purpose of the NNPF comprises the change of the picture resolution.

Clause 17. The method of any of clauses 1-16, wherein the plurality of candidates for the purpose comprise a change of a picture rate of the at least one picture.

Clause 18. The method of clause 17, wherein the change of the picture rate comprises an increase of the picture rate.

Clause 19. The method of any of clauses 17-18, wherein whether output picture rate information is indicated in the bitstream is dependent on whether the purpose of the NNPF comprises the change of the picture rate.

Clause 20. The method of any of clauses 1-19, wherein the plurality of candidates for the purpose comprise a change of a bit depth of a sample value in the at least one picture.

Clause 21. The method of clause 20, wherein the change of the bit depth comprises an increase of the bit depth.

Clause 22. The method of any of clauses 20-21, wherein whether output bit depth information is indicated in the bitstream is dependent on whether the purpose of the NNPF comprises the change of the bit depth.

Clause 23. The method of any of clauses 1-22, wherein the purpose of the NNPF is allowed to comprise a combination of at least two of the following: a change of a color format of the at least one picture, a change of a picture resolution of the at least one picture, a change of a picture rate of the at least one picture, or a change of a bit depth of a sample value in the at least one picture.

Clause 24. The method of any of clauses 1-23, wherein if the first indication indicates that the purpose of the NNPF does not comprise a change of a format of the at least one picture, the purpose of the NNPF comprises an improvement of visual quality of the at least one picture.

Clause 25. The method of clause 10, wherein the change of the format of the at least one picture is indicated by one or more unsigned integer 0-th order Exp-Golomb-coded syntax elements, or one or more unsigned integer syntax elements using N bits with N being an integer.

Clause 26. The method of clause 4, wherein each of the plurality of bits corresponds to one of the plurality of candidates for the purpose.

Clause 27. The method of any of clauses 1-3, wherein the first indication is indicated as an unsigned integer 0-th order Exp-Golomb-coded syntax element.

Clause 28. The method of clause 27, wherein each effective bit in the first indication corresponds to one of the plurality of candidates for the purpose.

Clause 29. The method of any of clauses 1-28, wherein a non-zero value of the first indication indicates that the NNPF is used as determined by an application.

Clause 30. The method of clause 29, wherein the non-zero value is the largest value in a valid range of the first indication.

Clause 31. The method of any of clauses 1-30, wherein the at least one picture comprises at least one decoded picture or at least one cropped decoded picture of the video.

Clause 32. The method of any of clauses 1-31, wherein the conversion includes encoding the video into the bitstream.

Clause 33. The method of any of clauses 1-31, wherein the conversion includes decoding the video from the bitstream.

Clause 34. An apparatus for video processing comprising a processor and a non-transitory memory with instructions thereon, wherein the instructions upon execution by the processor, cause the processor to perform a method in accordance with any of clauses 1-33.

Clause 35. A non-transitory computer-readable storage medium storing instructions that cause a processor to perform a method in accordance with any of clauses 1-33.

Clause 36. A non-transitory computer-readable recording medium storing a bitstream of a video which is generated by a method performed by an apparatus for video processing, wherein the method comprises: performing a conversion between the video and the bitstream, wherein a neural-network post-processing filter (NNPF) is applied on at least one picture associated with the video, the bitstream comprises a first indication indicating a purpose of the NNPF, one of a plurality of candidates for the purpose corresponds to a bit mask, and the bit mask is used for determining the purpose of the NNPF based on the first indication.

Clause 37. A method for storing a bitstream of a video, comprising: performing a conversion between the video and the bitstream, wherein a neural-network post-processing filter (NNPF) is applied on at least one picture associated with the video, the bitstream comprises a first indication indicating a purpose of the NNPF, one of a plurality of candidates for the purpose corresponds to a bit mask, and the bit mask is used for determining the purpose of the NNPF based on the first indication; and storing the bitstream in a non-transitory computer-readable recording medium.

### Example Device

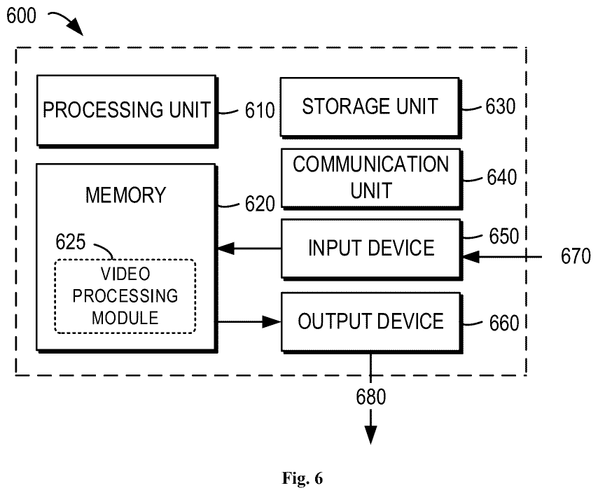

FIG. 6 illustrates a block diagram of a computing device 600 in which various embodiments of the present disclosure can be implemented. The computing device 600 may be implemented as or included in the source device 110 (or the video encoder 114 or 200) or the destination device 120 (or the video decoder 124 or 300).

It would be appreciated that the computing device 600 shown in FIG. 6 is merely for purpose of illustration, without suggesting any limitation to the functions and scopes of the embodiments of the present disclosure in any manner.

As shown in FIG. 6, the computing device 600 includes a general-purpose computing device 600. The computing device 600 may at least comprise one or more processors or processing units 610, a memory 620, a storage unit 630, one or more communication units 640, one or more input devices 650, and one or more output devices 660.

In some embodiments, the computing device 600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 600 can support any type of interface to a user (such as “wearable” circuitry and the like).

The processing unit 610 may be a physical or virtual processor and can implement various processes based on programs stored in the memory 620. In a multi-processor system, multiple processing units execute computer executable instructions in parallel so as to improve the parallel processing capability of the computing device 600. The processing unit 610 may also be referred to as a central processing unit (CPU), a microprocessor, a controller or a microcontroller.

The computing device 600 typically includes various computer storage medium. Such medium can be any medium accessible by the computing device 600, including, but not limited to, volatile and non-volatile medium, or detachable and non-detachable medium. The memory 620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 630 may be any detachable or non-detachable medium and may include a machine-readable medium such as a memory, flash memory drive, magnetic disk or another other media, which can be used for storing information and/or data and can be accessed in the computing device 600.

The computing device 600 may further include additional detachable/non-detachable, volatile/non-volatile memory medium. Although not shown in FIG. 6, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 640 communicates with a further computing device via the communication medium. In addition, the functions of the components in the computing device 600 can be implemented by a single computing cluster or multiple computing machines that can communicate via communication connections. Therefore, the computing device 600 can operate in a networked environment using a logical connection with one or more other servers, networked personal computers (PCs) or further general network nodes.

The input device 650 may be one or more of a variety of input devices, such as a mouse, keyboard, tracking ball, voice-input device, and the like. The output device 660 may be one or more of a variety of output devices, such as a display, loudspeaker, printer, and the like. By means of the communication unit 640, the computing device 600 can further communicate with one or more external devices (not shown) such as the storage devices and display device, with one or more devices enabling the user to interact with the computing device 600, or any devices (such as a network card, a modem and the like) enabling the computing device 600 to communicate with one or more other computing devices, if required. Such communication can be performed via input/output (I/O) interfaces (not shown).

In some embodiments, instead of being integrated in a single device, some or all components of the computing device 600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 600 may be used to implement video encoding/decoding in embodiments of the present disclosure. The memory 620 may include one or more video coding modules 625 having one or more program instructions. These modules are accessible and executable by the processing unit 610 to perform the functionalities of the various embodiments described herein.

In the example embodiments of performing video encoding, the input device 650 may receive video data as an input 670 to be encoded. The video data may be processed, for example, by the video coding module 625, to generate an encoded bitstream. The encoded bitstream may be provided via the output device 660 as an output 680.

In the example embodiments of performing video decoding, the input device 650 may receive an encoded bitstream as the input 670. The encoded bitstream may be processed, for example, by the video coding module 625, to generate decoded video data. The decoded video data may be provided via the output device 660 as the output 680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
performing a conversion between a video and a bitstream of the video, wherein a neural-network post-processing filter (NNPF) is applied on at least one picture associated with the video, the bitstream comprises a first indication indicating a purpose of the NNPF, one of a plurality of candidates for the purpose corresponds to a bit mask, and the bit mask is used for determining the purpose of the NNPF based on the first indication.

2. The method of claim 1, wherein one bit or one effective bit in the first indication indicates whether the purpose of the NNPF comprises one of the plurality of candidates for the purpose.

3. The method of claim 1, wherein the first indication comprises a syntax element nnpfc_purpose.

4. The method of claim 1, wherein the first indication is indicated as an unsigned integer using a plurality of bits.

5. The method of claim 4, wherein the number of the plurality of bits is one of 3, 4, 6, 8, 10, 16 or 32.

6. The method of claim 1, wherein if a value of a first bit in the first indication is equal to a first value, the purpose of the NNPF comprises a first candidate in the plurality of candidates for the purpose, or
if the value of the first bit is equal to a second value, the purpose of the NNPF does not comprise the first candidate for the purpose.

7. The method of claim 6, wherein the first value of 1, or the second value is 0.

8. The method of claim 1, wherein whether at least one format parameter for a filtering process using the NNPF is indicated in the bitstream is dependent on a result of applying a bitwise operation on the first indication and at least one bit mask, and the at least one bit mask is used for determining the purpose of the NNPF based on the first indication.

9. The method of claim 1, wherein whether at least one format parameter for a filtering process using the NNPF is indicated in the bitstream is dependent on a value of a bit or an effective bit in the first indication.

10. The method of claim 1, wherein the plurality of candidates for the purpose comprise a change of a format of the at least one picture.

11. The method of claim 1, wherein the plurality of candidates for the purpose comprise a change of a color format of the at least one picture.

12. The method of claim 11, wherein the change of the color format comprises a change from the color format to a further color format with a chroma subsampling rate less than a chroma subsampling rate of the color format, or
wherein whether a color format type is indicated in the bitstream is dependent on whether the purpose of the NNPF comprises the change of the color format.

13. The method of claim 1, wherein a non-zero value of the first indication indicates that the NNPF is used as determined by an application.

14. The method of claim 13, wherein the non-zero value is the largest value in a valid range of the first indication.

15. The method of claim 1, wherein the at least one picture comprises at least one decoded picture or at least one cropped decoded picture of the video.

16. The method of claim 1, wherein the conversion includes encoding the video into the bitstream.

17. The method of claim 1, wherein the conversion includes decoding the video from the bitstream.

18. An apparatus for video processing comprising a processor and a non-transitory memory with instructions thereon, wherein the instructions upon execution by the processor, cause the processor to perform acts comprising:
performing a conversion between a video and a bitstream of the video, wherein a neural-network post-processing filter (NNPF) is applied on at least one picture associated with the video, the bitstream comprises a first indication indicating a purpose of the NNPF, one of a plurality of candidates for the purpose corresponds to a bit mask, and the bit mask is used for determining the purpose of the NNPF based on the first indication.

19. A non-transitory computer-readable storage medium storing instructions that cause a processor to perform acts comprising:
performing a conversion between a video and a bitstream of the video, wherein a neural-network post-processing filter (NNPF) is applied on at least one picture associated with the video, the bitstream comprises a first indication indicating a purpose of the NNPF, one of a plurality of candidates for the purpose corresponds to a bit mask, and the bit mask is used for determining the purpose of the NNPF based on the first indication.

20. A non-transitory computer-readable recording medium storing a bitstream of a video which is generated by a method performed by an apparatus for video processing, wherein the method comprises:
performing a conversion between the video and the bitstream, wherein a neural-network post-processing filter (NNPF) is applied on at least one picture associated with the video, the bitstream comprises a first indication indicating a purpose of the NNPF, one of a plurality of candidates for the purpose corresponds to a bit mask, and the bit mask is used for determining the purpose of the NNPF based on the first indication.
